(19) United States
(12) Patent Application Publication
(10) Pub. No.: US 2018/0025719 A1
(43) Pub. Date: Jan. 25, 2018

(54) Low-Power-Consumption Active Noise-Reduction In-Ear Music Earphone and Method for Noise Reduction

(71) Applicant: Shenzhen Aerospace Golden Shine Technology Co., Ltd, Shenzhen (CN)

(72) Inventors: Qingshan Bao, Shenzhen (CN); Shangfeng Shi, Shenzhen (CN)

(21) Appl. No.: 15/723,165

(22) Filed: Oct. 2, 2017

Related U.S. Application Data
(63) Continuation-in-part of application No. 15/109,135, filed on Jun. 30, 2016.

(30) Foreign Application Priority Data
Feb. 9, 2015 (CN) 201510068034.9

(51) Int. Cl. G10K 11/178; H04R 1/10

(52) U.S. Cl. CPC G10K 11/1786; H04R 1/1016; G10K 11/1788; G10K 2210/3028; G10K 2210/3044; G10K 2210/1081; H04R 2460/03; G10K 2210/3214

(57) ABSTRACT

An earphone and a method for noise reduction in the earphone are disclosed in the present invention. The earphone includes: an audio circuit configured for outputting an audio signal; a noise cancellation circuit configured for detecting an ambient noise signal, determining phase of the ambient noise signal and reversing such phase to generate an anti-noise signal having same level and opposite phase as that of the ambient noise signal; a combiner unit configured for combining the audio signal with the anti-noise signal to generate a combined signal; a speaker electrically connected to the combiner unit and configured for receiving and outputting the combined signal; wherein, the combiner unit includes a first diode and a second diode electrically connected to the speaker in parallel; the audio circuit is electrically connected to the first diode; and, the noise cancellation circuit is electrically connected to the second diode.

### CROSS REFERENCE TO RELATED APPLICATIONS

This application is a continuation-in-part application of U.S. patent application Ser. No. 15/109,135 filed on Jun. 30, 2016, and the U.S. patent application Ser. No. 15/109,135 is a national phase application of PCT Application No. PCT/CN2015/080704 filed on Jun. 3, 2015, which claims the benefits of Chinese Patent Application No. 201510068034.9 filed on Feb. 9, 2015. All the above are hereby incorporated by reference.

### TECHNICAL FIELD

The present disclosure relates to a noise-reduction earphone, and more particularly to an in-ear music earphone having low-power-consumption and active noise-reduction and a method for noise reduction thereof.

### BACKGROUND ART

Power supply sources are usually very small in mobile electronic devices due to their size and weight. A battery capacity of an active noise-reduction music earphone never exceed 20 mA, therefore, it should be noted that power consumption of the earphone would result in an energy crisis. The minimum power consumption such earphone in the prior art is 12 mA on average, and a continuous service time thereof never exceeds 2 hours. Therefore, it is necessary to provide a new earphone that has low power consumption. Additionally, the earphone in the prior art also has the defects in lower noise-reduction depth, narrower width, and ground noise present in noise reduction while the earphone startup.

### SUMMARY

An object of the present disclosure is to provide an in-ear music earphone that has low power consumption and active noise-reduction, which can solve the technical problems in high power consumption and short continuous service time of the earphone in the prior art.

In one aspect of the disclosure, an earphone comprises: an audio circuit configured for providing audio signal; a noise cancellation circuit configured for detecting ambient noise signal, determining phase of the ambient noise signal and reversing such phase to generate an anti-noise signal having same level and opposite phase as that of the ambient noise signal; a combiner unit configured for combining the audio signal with the anti-noise signal to generate a combined signal; and a speaker electrically connected to the combiner unit and configured for receiving and playing the combined signal; wherein, the combiner unit includes a first diode and a second diode electrically connected to the speaker in parallel; and, the audio circuit is electrically connected to the first diode; the noise cancellation circuit is electrically connected to the second diode.

In one embodiment, the noise cancellation circuit includes: a noise detector configured for obtaining ambient noise signals having different frequency bands; an analog filter electrically connected to the noise detector and configured for outputting part of the ambient noise signals having specific frequency bands; a digital filter electrically connected to the analog filter and configured for determining phases of the ambient noise signals having specific frequency bands and reversing such phases to generate anti-noise signals corresponding to the ambient noise signals.

In one embodiment, a voltage drop of the first diode is less than 0.1V.

In one embodiment, a voltage drop of the second diode is less than 0.1V.

In one embodiment, the speaker includes a first positive electrode electrically connected to the first diode and the second diode, and a first negative electrode grounded.

In one embodiment, the specific frequency bands of the ambient noise signals are ranged from 20 Hz to 2500 Hz.

In one embodiment, the analog filter having amplification module configured for amplifying the ambient noise signals.

In one embodiment, the noise detector includes at least two sound pickup devices selectively electrically connected to the analog filter via a selecting switch for providing ambient noise signals from one sound pickup device to the analog filter.

In another aspect of the disclosure, a method of noise reduction in an earphone, comprises: providing an audio signal by an audio circuit; detecting ambient noise signal, determining phase of the ambient noise signal and reversing such phase to generate an anti-noise signal having same level and opposite phase as that of the ambient noise signal by a noise cancellation circuit; combining the audio signal with the anti-noise signal to generate a combined signal by a combiner unit; receiving and playing the combined signal by a speaker; wherein, the combiner unit includes a first diode and a second diode electrically connected to the speaker in parallel; the audio circuit is electrically connected to the first diode; and, the noise cancellation circuit is electrically connected to the second diode.

In one embodiment, the noise cancellation circuit includes: a noise detector configured for obtaining ambient noise signals having different frequency bands; an analog filter electrically connected to the noise detector and configured for outputting part of the ambient noise signals having specific frequency bands; a digital filter electrically connected to the analog filter and configured for determining phases of the ambient noise signals having specific frequency bands and reversing such phases to generate anti-noise signals corresponding to the ambient noise signals.

In one embodiment, the speaker includes a first positive electrode electrically connected to the first diode and the second diode, and a first negative electrode grounded.

In one embodiment, the first diode includes a second positive electrode and a second negative electrode, the audio circuit is electrically connected to the second positive electrode of the first diode, and the second negative electrode of the first diode is electrically connected to the first positive electrode of the speaker.

In one embodiment, the second diode includes a third positive electrode and a third negative electrode, the digital filter is electrically connected to the third positive electrode, and the third negative electrode is electrically connected to the first positive electrode of the speaker.

In one embodiment, the noise detector includes at least two sound pickup devices selectively electrically connected to the analog filter via a selecting switch for providing ambient noise signals from one sound pickup device to the analog filter.

In one embodiment, a voltage drop of the first diode is less than 0.1V.

In one embodiment, a voltage drop of the second diode is less than 0.1V.

In one embodiment, the specific frequency bands of the ambient noise signals are ranged from 20 Hz to 2500 Hz.

The earphone provided by the present disclosure has the following advantages: since the audio signal and the anti-noise signal are combined by the combiner unit that is consisted of two diodes as described above, the power consumption of the earphone is greatly reduced. Specifically, the power consumption of the earphone is only one-tenth of a traditional earphone in which a power amplifier is employed for signals mixing. Additionally, since the analog filter and the digital filter are used as parts of the noise cancellation circuit, the time delay of the signal can be reduced, and the power consumption of the earphone can be further reduced.

### BRIEF DESCRIPTION OF THE DRAWINGS

The above and/or additional objects, features and advantages of the present disclosure, will be further elucidated by the following illustrative and non-limiting detailed description of embodiment of the present disclosure, with reference to the appended drawings, wherein:

FIG. 1 is a schematic view of an earphone according to one embodiment of the present disclosure, which communicates with a mobile phone;

FIG. 2 is a block diaphragm of the earphone according to the embodiment of the present disclosure;

FIG. 3 is a flow chart of a method for noise reduction in the earphone according to the embodiment of the present disclosure.

### DESCRIPTION OF THE PREFERRED EMBODIMENT

The present invention will be further illustrated below with reference to the attached drawings and the embodiments. The description in more detail aims to help to understand the present invention, instead of limiting the present invention. According to the contents disclosed by the present invention, those skilled in the art shall understand that the present invention can be implemented even without some or all of these specific details. Under other circumstances, to avoid weakening the inventiveness of the present invention, the well-known circuits, methods, operation processes and the like will not be described in detail.

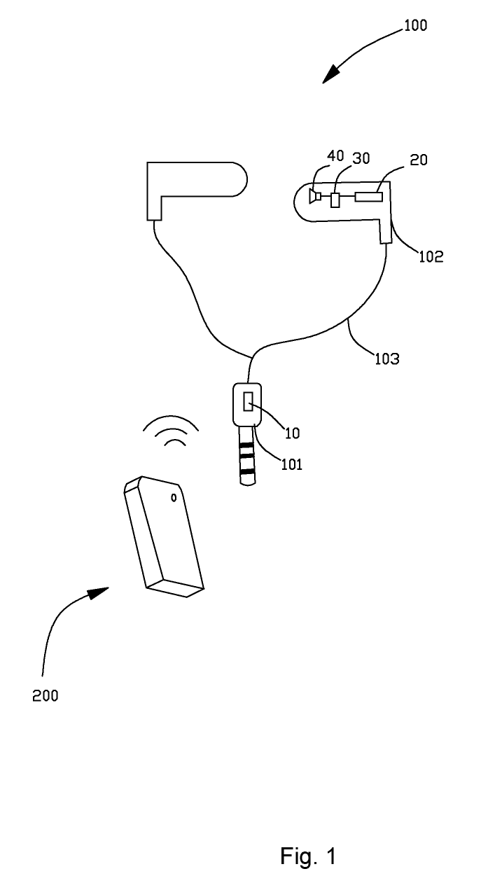

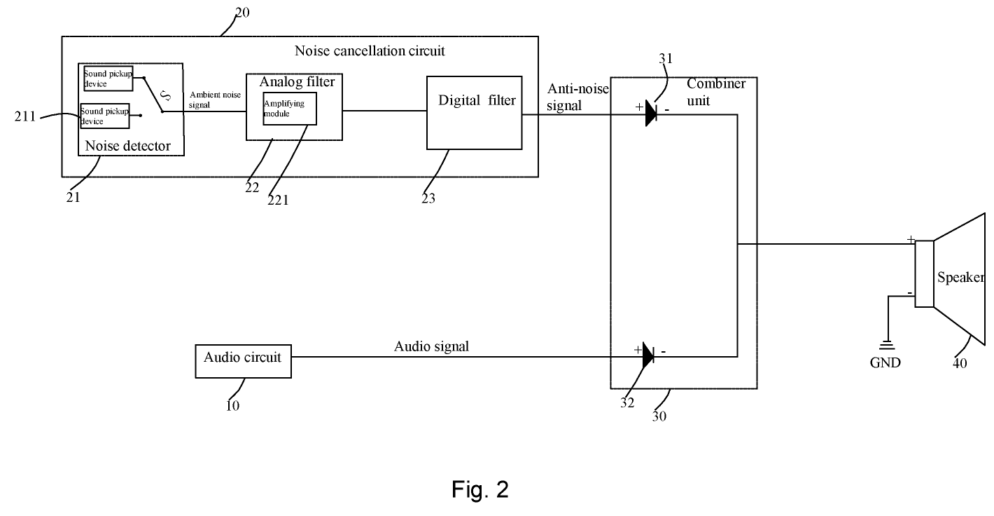

As shown in FIG. 1 and FIG. 2, an in-ear music earphone having low-power-consumption and active noise-reduction is disclosed in the present disclosure. The earphone 100 includes an audio plug 101, an in-ear earplug 102 and a connecting wire 103 electrically connected between the audio plug 101 and the earplug 102.

The earphone 100 further includes an audio circuit 10 configured for providing audio signal, a noise cancellation circuit 20 configured for detecting an ambient noise signal, determining phase of the ambient noise signal and reversing such phase to generate an anti-noise signal having same level and opposite phase as that of the ambient noise signal; a combiner unit 30 configured for combining the audio signal with the anti-noise signal to generate a combined signal; and a speaker 40 electrically connected to the combiner unit 30 and configured for receiving and playing the combined signal in the ear canal of a user. The audio circuit 10 is arranged in the audio plug 10. The noise cancellation circuit 20, the combiner unit 30 and speaker 40 are received in the earplug 102. The audio circuit 10 and the noise cancellation circuit 20 are electrically connected to the combiner unit 30 in parallel. Preferably, the audio circuit 10 is electrically connected to the combiner unit 30 via the connecting wire 103.

The audio plug 101 may be wire-connected or wire-lessly connected to an audio generating device 200. The audio generating device 200 is configured for generating audio signal, and it may be a music player such as MP3, mobile phone, etc. The audio circuit 10 may obtain the audio signal, such as music signal, from the audio generating device 200 and then providing such audio signal to the combiner unit 30.

The noise cancellation circuit 20 comprises a noise detector 21, a analog filter 22 electrically connected to the noise detector 21, and a digital filter 23 having an input end electrically connected to the analog filter 22 and an output end electrically connected to the combiner unit 30.

The noise detector 21 may be a sound pickup device 211 located on an outside of the earplug 102 to detect ambient noise signals existed in the ambient space of the ear canal of the user. The sound pickup device 211 may be a microphone. Alternatively, the noise detector 20 may include at least two sound pickup devices 211 and a selecting switch S. The at least two sound pickup devices 211 are selectively electrically connected to the analog filter 22 via the selecting switch S so that the ambient noise signals from one of the sound pickup devices 211 can be provided to the analog filter 22. In the embodiment, one of the sound pickup devices 211 may be located on the outside of the earplug 102, and the other of the sound pickup devices 211 may be located on the audio generating device 200 such as mobile phone, etc. The sound pickup device 211 may be the microphone of the mobile phone. By such configuration, the at least two sound pickup devices can detect the noise sound in different ambient spaces. Additionally, the cost of the earphone can be reduced, since the microphone of the mobile phone can be used as the sound pickup device, i.e. the noise detector.

The analog filter 22 may be a low-pass filter, and have an amplifier module 221 configured for amplifying the ambient noise signals received from the noise detector 21. The analog filter 22 filters out part of the ambient noise signals that have unwanted frequency bands, then attenuates and cancels such ambient noise signals. And, the residual part of the ambient noise signals having the specific frequency bands are sent to the digital filter 23 by the analog filter 22. Preferably, the specific frequency bands of the ambient noise signals may be ranged from 20 Hz to 2500 Hz.

The digital filter 23 may be a band-cut filter, and receives the ambient noise signals from the analog filter 22. The digital filter 23 may have an algorithm module processing the ambient noise signals, determining phases of the ambient noise signals and reversing such phases to generate anti-noise signals. The anti-noise signals have the same level and opposite phase as that of the ambient noise signal. Preferably, the algorithm module processes each of the noise signals and reverses the phase of the noise signal by 180 degree to generate the anti-noise signal corresponding to the noise signal. Then, the digital filter 23 sends the anti-noise signals to the combiner unit 30.

The combiner unit 30 is configured to combine the audio signal from the audio circuit 10 with the anti-noise signals from the digital filter 23 to generate a combined signal, and send the combined signal to the speaker 40. Specifically, the combiner unit 30 includes a first diode 32 and a second diode 31 electrically connected to the speaker 40 in parallel. The first diode 32 includes a second positive electrode and a second negative electrode. The second diode 31 includes a third positive electrode and a third negative electrode. Both of the second negative electrode and the third negative electrode are electrically connected to the speaker 40. The audio circuit 10 is electrically connected to the second positive electrode of the first diode 32 via the connecting wire 103, and the output end of the digital filter 23 is electrically connected to the third positive electrode of the second diode 31. Preferably, voltage drops of both of the first and second diodes may be less than 0.1V. In the embodiment, forward bias voltages of the first diode 32 and the second diode 31 may be 0.2V; and reverse breakdown voltages of the first diode 32 and the second diode 31 may be 20V. By the configuration of such diodes, low signal attenuation and distortion may be presented, low power consumption can be realized, and since the diodes have a function in reverse cut-off, the noise cancellation circuit and audio circuit can be protected.

The speaker 40 is configured for playing the combined signal in the ear canal of the user. The audio signal may be played for music. The anti-noise signal can cancel out the ambient noise having the same level and opposite phase as that of the anti-noise signal in the ear canal for noise reduction in the earphone. The speaker 40 includes a first positive electrode and a first negative electrode. Both of the second negative electrode and the third negative electrode are electrically connected to the first positive electrode of the speaker 40, and the first negative electrode of the speaker 40 is grounded. With such configuration, since the first negative electrode of the speaker is ground, reverse breakdown never occur in the first and second diodes.

In some embodiments, the noise cancellation circuit 20 can be selected to be on or off. When the noise cancellation circuit 20 is off, the music earphone can be used as common earphone without noise cancellation function.

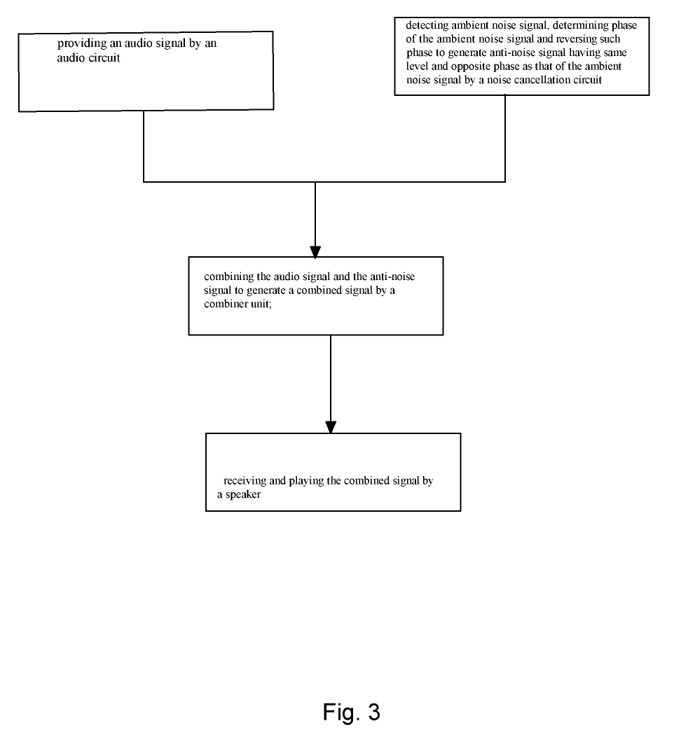

As shown in FIG. 3, a method for noise reduction in the earphone is disclosed in the present disclosure. The method comprises the following steps:

providing an audio signal by the audio circuit 10;

detecting an ambient noise signal, determining phase of the ambient noise signal and reversing such phase to generate an anti-noise signal having same level and opposite phase as that of the ambient noise signal by the noise cancellation circuit 20; specifically, obtaining ambient noise signals having different frequency bands by the noise detector 21; outputting part of the ambient noise signals having specific frequency bands by the analog filter 22; determining phases of the ambient noise signals and reversing such phases to generate anti-noise signals by the digital filter 23;

combining the audio signal with the anti-noise signal to generate a combined signal by the combiner unit 30;

receiving and playing the combined signal by the speaker 40 in the ear canal of the user. The audio signal may be played for music. The anti-noise signal can cancel out the ambient noise having the same level and opposite phase as that of the anti-noise signal in the ear canal for realizing noise reduction in the earphone.

By experiments, the in-ear music earphone in some embodiments can provide the noise-reduction depth of 35 db, the noise-reduction width of 2 kHz. The continuous service time of the earphone in the present disclosure is up to 20 hours under the condition that the battery capacity of the earphones is only 20 mA, and the power consumption of the earphone may be one-tenth of the traditional earphones.

What is claimed is:

1. An earphone, comprising:
an audio circuit configured for providing an audio signal;
a noise cancellation circuit configured for detecting an ambient noise signal, determining phase of the ambient noise signal and reversing such phase to generate an anti-noise signal having same level and opposite phase as that of the ambient noise signal;
a combiner unit configured for combining the audio signal with the anti-noise signal to generate a combined signal;
a speaker electrically connected to the combiner unit and configured for receiving and playing the combined signal; wherein,
the combiner unit includes a first diode and a second diode electrically connected to the speaker in parallel;
the audio circuit is electrically connected to the first diode; and,
the noise cancellation circuit is electrically connected to the second diode.

2. The earphone according to claim 1, wherein, the noise cancellation circuit includes:
a noise detector configured for obtaining ambient noise signals having different frequency bands;
an analog filter electrically connected to the noise detector and configured for outputting part of the ambient noise signals having specific frequency bands;
a digital filter electrically connected to the analog filter and configured for determining phases of the ambient noise signals having specific frequency bands and reversing such phases to generate anti-noise signals.

3. The earphone according to claim 1, wherein, a voltage drop of the first diode is less than 0.1V

4. The earphone according to claim 3, wherein, a voltage drop of the second diode is less than 0.1V.

5. The earphone according to claim 4, wherein, the speaker includes a first positive electrode electrically connected to the first diode and the second diode, and a first negative electrode grounded.

6. The earphone according to claim 2, wherein, the specific frequency bands of the ambient noise signals are ranged from 20 Hz to 2500 Hz.

7. The earphone according to claim 2, wherein, the analog filter having amplification module configured for amplifying the ambient noise signals.

8. The earphone according to claim 2, wherein, the noise detector includes at least two sound pickup devices selectively electrically connected to the analog filter via a selecting switch for providing ambient noise signals from one of the sound pickup devices to the analog filter.

9. A method for noise reduction in an earphone, comprising:
providing an audio signal by an audio circuit;
detecting an ambient noise signal, determining phase of the ambient noise signal and reversing such phase to generate an anti-noise signal having same level and opposite phase as that of the ambient noise signal by a noise cancellation circuit;
combining the audio signal with the anti-noise signal to generate a combined signal by a combiner unit;
receiving and playing the combined signal by a speaker; wherein,
the combiner unit includes a first diode and a second diode electrically connected to the speaker in parallel;
the audio circuit is electrically connected to the first diode; and
the noise cancellation circuit is electrically connected to the second diode.

10. The method for noise reduction in the earphone according to claim 9, wherein, the noise cancellation circuit includes:
a noise detector configured for obtaining ambient noise signals having different frequency bands;
an analog filter electrically connected to the noise detector and configured for outputting part of the ambient noise signals having specific frequency bands;
a digital filter electrically connected to the analog filter and configured for determining phases of the ambient noise signals having specific frequency bands and reversing such phases to generate anti-noise signals.

11. The method for noise reduction in the earphone according to claim 9, wherein,
the speaker includes a first positive electrode electrically connected to the first diode and the second diode, and a first negative electrode grounded.

12. The method for noise reduction in the earphone according to claim 11, wherein, the first diode includes a second positive electrode and a second negative electrode, the audio circuit electrically connected to the second positive electrode, and the second negative electrode electrically connected to the first positive electrode of the speaker.

13. The method for noise reduction in the earphone according to claim 12, wherein,
the second diode includes a third positive electrode and a third negative electrode, the digital filter electrically connected to the third positive electrode, and the third negative electrode is electrically connected to the first positive electrode of the speaker.

14. The method for noise reduction in the earphone according to claim 13, wherein, a voltage drop of the first diode is less than 0.1V

15. The method for noise reduction in the earphone according to claim 14, wherein, a voltage drop of the second diode is less than 0.1V.

16. The method for noise reduction in the earphone according to claim 10, wherein, the noise detector includes at least two sound pickup devices selectively electrically connected to the analog filter via a selecting switch for providing ambient noise signals from one of the sound pickup devices to the analog filter.

17. The method for noise reduction in the earphone according to claim 10, wherein, the specific frequency bands of the ambient noise signals are ranged from 20 Hz to 2500 Hz.
